(19) United States
(12) Patent Application Publication
(10) Pub. No.: US 2015/0211462 A1
(43) Pub. Date: Jul. 30, 2015

(54) FUEL INJECTOR NOZZLES WITH AT LEAST ONE MULTIPLE INLET PORT AND/OR MULTIPLE OUTLET PORT

(71) Applicant: 3M INNOVATIVE PROPERTIES COMPANY, St. Paul, MN (US)

(72) Inventors: Scott M. Schnobrich, Cottage Grove, MN (US); Barry S. Carpenter, Oakdale, MN (US); Barbara A. Fipp, Minneapolis, MN (US); James C. Novack, Hudson, WI (US); David H. Redinger, Afton, MN (US); Ryan C. Shirk, Mendota Heights, MN (US)

(21) Appl. No.: 14/417,820

(22) PCT Filed: Aug. 1, 2013
(86) PCT No.: PCT/US2013/053198

§ 371 Date: Jan. 28, 2015

Related U.S. Application Data
(60) Provisional application No. 61/678,330, filed on Aug. 1, 2012.

(51) Int. Cl. F02M 61/18; F02M 61/16

(52) U.S. Cl. CPC F02M 61/1813; F02M 61/1826; F02M 61/1833; F02M 61/168

(57) ABSTRACT

Nozzles and method of making the same are disclosed. The disclosed nozzles have at least one nozzle through-hole therein, wherein the at least one nozzle through-hole has (i) a single inlet opening along an inlet face and multiple outlet openings along an outlet face or (ii) multiple inlet openings along an inlet face and a single outlet opening along an outlet face. Fuel injectors containing the nozzle are also disclosed. Methods of making and using nozzles and fuel injectors are further disclosed.

### FIELD OF THE INVENTION

This invention generally relates to nozzles suitable for use in a fuel injector for an internal combustion engine. The invention is further applicable to fuel injectors incorporating such nozzles. This invention also relates to methods of making such nozzles, as well as methods of making fuel injectors incorporating such nozzles. The invention further relates to methods of using nozzles and fuel injectors in vehicles.

### BACKGROUND

There are three basic types of fuel injector systems. Those that use port fuel injection (PFI), gasoline direct injection (GDI), and direct injection (DI). While PFI and GDI use gasoline as the fuel, DI uses diesel fuel. Efforts continue to further develop fuel injector nozzles and fuel injection systems containing the same so as to potentially increase fuel efficiency and reduce hazardous emissions of internal combustion engines, as well as reduce the overall energy requirements of a vehicle comprising an internal combustion engine.

### SUMMARY OF THE INVENTION

The present invention is directed to fuel injector nozzles. In one exemplary embodiment, the fuel injector nozzle comprises an inlet face; an outlet face opposite the inlet face; and at least one nozzle through-hole comprising (i) a single inlet opening on the inlet face connected to multiple outlet openings on the outlet face by a cavity defined by an interior surface, or (ii) multiple inlet openings on the inlet face connected to a single outlet opening on the outlet face by a cavity defined by an interior surface.

The present invention is further directed to fuel injectors. In one exemplary embodiment, the fuel injector comprises any one of the herein-disclosed nozzles of the present invention incorporated therein.

The present invention is even further directed to fuel injection systems. In one exemplary embodiment, the fuel injection system comprises any one of the herein-disclosed nozzles or fuel injectors of the present invention incorporated therein.

The present invention is also directed to methods of making nozzles. In one exemplary embodiment, the method of making a nozzle of the present invention comprises making any of the herein-described nozzles.

In another exemplary embodiment, the method of making a nozzle of the present invention comprises: forming at least one nozzle through-hole within the fuel injector nozzle such that the at least one nozzle through-hole extends from an inlet face to an outlet face opposite the inlet face of the nozzle, the at least one nozzle through-hole comprising (i) a single inlet opening on the inlet face connected to multiple outlet openings on the outlet face by a cavity defined by an interior surface, or (ii) multiple inlet openings on the inlet face connected to a single outlet opening on the outlet face by a cavity defined by an interior surface.

The present invention is also directed to methods of making fuel injectors for use in an internal combustion engine of a vehicle. In one exemplary embodiment, the method of making a fuel injector comprises incorporating any one of the herein-described nozzles into the fuel injector.

The present invention is further directed to methods of making fuel injection systems of an internal combustion vehicle. In one exemplary embodiment, the method of making a fuel injection system of a vehicle comprises incorporating any one of the herein-described nozzles or fuel injectors into the fuel injection system.

The present invention is even further directed to methods of using fuel injection systems of an internal combustion vehicle. In one exemplary embodiment, the method of using a fuel injection system comprises: introducing two or more fuel components into a nozzle of a fuel injection system such that each fuel component independently enters separate inlet openings of a single nozzle through-hole and exits a single outlet opening of the single nozzle through-hole so as to mix the two or more fuel components from the two or more fuel reservoirs as the fuel components travel through the nozzle.

### BRIEF DESCRIPTION OF DRAWINGS

The invention may be more completely understood and appreciated in consideration of the following detailed description of various embodiments of the invention in connection with the accompanying drawings, in which:

FIG. 1 is a cross-sectional view of an exemplary nozzle of the present invention;

FIG. 2 is a cross-sectional view of another exemplary nozzle of the present invention;

FIG. 3 is a top view of an exemplary nozzle of the present invention;

FIG. 4 is a cross-sectional view of another exemplary nozzle of the present invention;

FIG. 5 is a cross-sectional view of another exemplary nozzle of the present invention;

FIGS. 6-7 are perspective views of cavities of exemplary nozzle through-holes of the present invention;

FIGS. 8A-8C are various views of an exemplary cavity of a nozzle through-hole of the present invention;

FIG. 9 is a schematic view of an exemplary fuel injection system of the present invention;

FIG. 10 is a schematic view of another exemplary fuel injection system of the present invention; and

FIG. 11 is a schematic view of another exemplary fuel injection system of the present invention.

In the specification, a same reference numeral used in multiple figures refers to the same or similar elements having the same or similar properties and functionalities.

### DETAILED DESCRIPTION

The disclosed nozzles represent improvements to nozzles disclosed in (1) International Patent Application Publication WO2011/014607, which published on Feb. 3, 2011, and (2) International Patent Application Serial No. US2012/023624 (3M Docket No. 67266WO003 entitled “Nozzle and Method of Making Same”) filed on Feb. 2, 2012, the subject matter and disclosure of both of which are herein incorporated by reference in their entirety. The disclosed nozzles provide one or more advantages over prior nozzles as discussed herein. For example, the disclosed nozzles can advantageously be incorporated into fuel injector systems to improve fuel efficiency. The disclosed nozzles can be fabricated using multiphoton, such as two photon, processes like those disclosed in International Patent Application Publication WO2011/014607 and International Patent Application Serial No. US2012/023624. In particular, multiphoton processes can be used to fabricate various microstructures, which can at least include one or more hole forming features. Such hole forming features can, in turn, be used as molds to fabricate holes for use in nozzles or other applications.

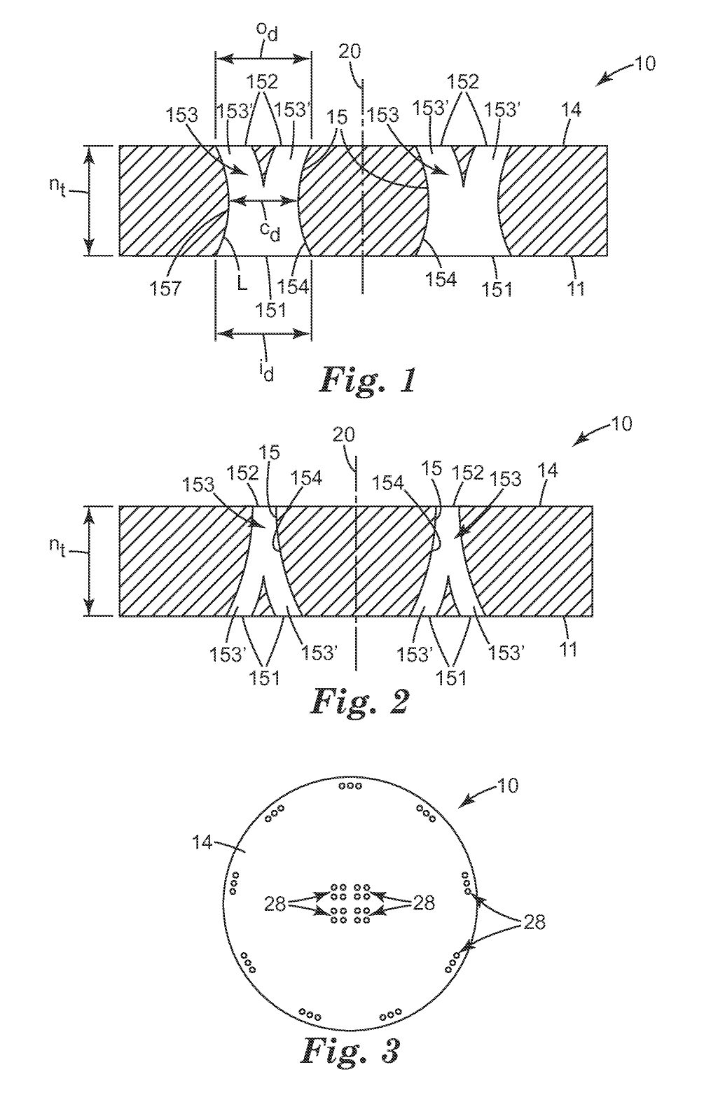

it should be understood that the term “nozzle” may have a number of different meanings in the art. In some specific references, the term nozzle has a broad definition. For example, U.S. Patent Publication No. 2009/0308953 A1 (Palestrant et al.), discloses an “atomizing nozzle” which includes a number of elements, including an occluder chamber 50. This differs from the understanding and definition of nozzle put forth herewith. For example, the nozzle of the current description would correspond generally to the orifice insert 24 of Palestrant et al. In general, the nozzle of the current description can be understood as the final tapered portion of an atomizing spray system from which the spray is ultimately emitted, see e.g., Merriam Webster's dictionary definition of nozzle (“a short tube with a taper or constriction used (as on a hose) to speed up or direct a flow of fluid.” Further understanding may be gained by reference to U.S. Pat. No. 5,716,009 (Ogihara et al.) issued to Nippondenso Co., Ltd. (Kariya, Japan). In this reference, again, fluid injection “nozzle” is defined broadly as the multi-piece valve element 10 (“fuel injection valve 10 acting as fluid injection nozzle . . . ”—see col. 4, lines 26-27 of Ogihara et al.). The current definition and understanding of the term “nozzle” as used herein would relate, e.g., to first and second orifice plates 130 and 132 and potentially sleeve 138 (see FIGS. 14 and 15 of Ogihara et al.), for example, which are located immediately proximate the fuel spray. A similar understanding of the term “nozzle” to that described herein is used in U.S. Pat. No. 5,127,156 (Yokoyama et al.) to Hitachi, Ltd. (Ibaraki, Japan). There, the nozzle 10 is defined separately from elements of the attached and integrated structure, such as “swirler” 12 (see FIG. 1(II)). The above-defined understanding should be understood when the term “nozzle” is referred to throughout the remainder of the description and claims.

The disclosed nozzles include one or more nozzle through-holes strategically incorporated into the nozzle structure, wherein at least one nozzle through-hole comprises (i) a single inlet opening on an inlet face of the nozzle connected to multiple outlet openings on an outlet face of the nozzle by a cavity defined by an interior surface, or (ii) multiple inlet openings on the inlet face connected to a single outlet opening on the outlet face by a cavity defined by an interior surface. The one or more nozzle through-holes provide one or more of the following properties to the nozzle: (1) the ability to provide variable fluid flow through a single nozzle through-hole or through multiple nozzle through-holes (e.g., the combination of increased fluid flow through one or more outlet openings and decreased fluid flow through other outlet openings of the same nozzle through-hole or of multiple nozzle through-holes) by selectively designing individual cavity passages (i.e., cavity passages 153′ discussed below) extending along a length of a given nozzle through-hole), (2) the ability to provide multi-directional fluid flow relative to an outlet face of the nozzle via a single nozzle through-hole or multiple nozzle through-holes, (3) the ability to provide multi-directional off-axis fluid flow relative to a central normal line extending perpendicularly through the nozzle outlet face via a single nozzle through-hole or multiple nozzle through-holes, and (4) the ability to mix two or more fuel components entering multiple inlet openings and exiting a single outlet opening of a single nozzle through-hole.

FIGS. 1-5 depict various views of exemplary fuel injector nozzles 10 of the present invention. As shown in FIG. 1, exemplary fuel injector nozzle 10 comprises an inlet face 11; an outlet face 14 opposite inlet face 11; and at least one nozzle through-hole 15 comprising a single inlet opening 151 on inlet face 11 connected to multiple outlet openings 152 on outlet face 14 by a cavity 153 defined by an interior surface 154. As shown in FIG. 2, exemplary fuel injector nozzle 10 comprises inlet face 11; outlet face 14 opposite inlet face 11; and at least one nozzle through-hole 15 comprising multiple inlet openings 151 on inlet face 11 connected to a single outlet opening 151 on outlet face 14 by a cavity 153 defined by an interior surface 154.

As shown in FIGS. 1-2, nozzle through-holes 15 of exemplary nozzles 10 comprise multiple cavity passages 153′ extending along cavity 153, wherein each cavity passage 153′ leads to one outlet opening 152 or extends from one inlet opening 151.

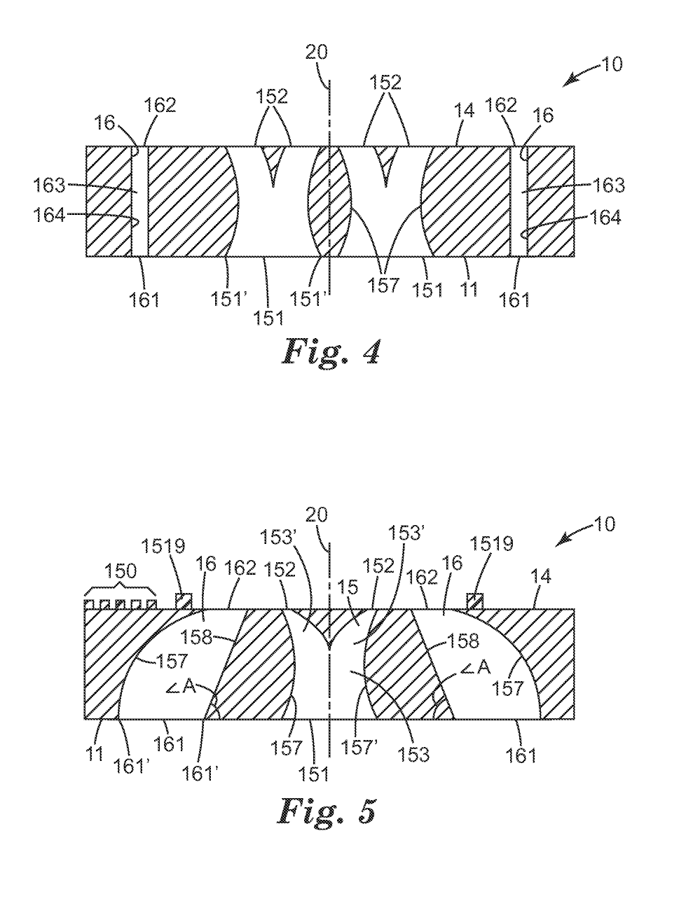

As shown in FIGS. 3-4, nozzles 10 of the present invention may comprise one or more arrays 28, wherein each array 28 comprises one or more nozzle through-holes 15 and/or one or more nozzle through-holes 16. As shown in FIG. 4, each nozzle through-hole 16 comprises a single inlet opening 161 along inlet face 11 and a single outlet opening 162 along outlet face 14.

As shown in FIG. 5, exemplary nozzles 10 of the present invention may further comprise a number of optional, additional features. Suitable optional, additional features include, but are not limited to, one or more anti-coking microstructures 150 positioned along any portion of outlet face 14, and one or more fluid impingement structures 1519 along any portion of outlet face 14.

As shown in FIGS. 1-8C, nozzles 10 of the present invention may comprise nozzle through-holes 15 and 16, wherein each nozzle through-hole 15/16 independently comprises the following features: (i) one or more inlet openings 151/161, each of which has its own independent shape and size, (ii) one or more outlet openings 152/163, each of which has its own independent shape and size, (iii) an internal surface 154/164 profile that may include one or more curved sections 157, one or more linear sections 158, or a combination of one or more curved sections 157 and one or more linear sections 158, and (iv) an internal surface 154 profile that may include two or more cavity passages 153′ extending from multiple inlet openings 151 and merging into a single cavity passage 153′ extending to a single outlet opening 152, or a single cavity passages 153′ extending from a single inlet opening 151 and separating into two or more cavity passages 153′ extending to multiple outlet openings 152. Selection of these features for each independent nozzle through-hole 15/16 enables nozzle 10 to provide (1) substantially equal fluid flow through nozzle through-holes 15/16 (i.e., fluid flow that is essentially the same exiting each multiple outlet opening 152 of each of nozzle through-holes 15 and/or each outlet opening 162 of each of nozzle through-hole 16), (2) variable fluid flow through any one nozzle through-hole 15 (i.e., fluid flow that is not the same exiting the multiple outlet openings 152 of a given nozzle through-hole 15), (3) variable fluid flow through any two or more nozzle through-holes 15/16 (i.e., fluid flow that is not the same exiting the multiple outlet openings 152 of a given nozzle through-hole 15 and/or each outlet opening 162 of each of nozzle through-hole 16), (4) single- or multi-directional fluid streams exiting a single nozzle through-hole 15, multiple nozzle through-holes 15, or any combination of nozzle through-holes 15/16, (5) linear and/or curved fluid streams exiting nozzle through-holes 15/16, and (5) parallel and/or divergent and/or parallel followed by divergent fluid streams exiting nozzle through-holes 15/16.

In some embodiments, at least one of nozzle through-holes 15/16 has an inlet opening 151/161 axis of flow, a cavity 153/163 axis of flow and an outlet opening 152/162 axis of flow, and at least one axis of flow is different from at least one other axis of flow. As used herein, the “axis of flow” is defined as the central axis of a stream of fuel as the fuel flows into, through or out of nozzle through-hole 15/16. In the case of a nozzle through-hole 15 having multiple inlet openings 151, multiple outlet openings 152 or both, the nozzle through-hole 15 can have a different axis of flow corresponding to each of the multiple openings 151/152.

In some embodiments, inlet opening 151/161 axis of flow may be different from outlet opening 152/162 axis of flow. In other embodiments, each of inlet opening 151/161 axis of flow, cavity 153/163 axis of flow and outlet opening 152/162 axis of flow are different from one another. In other embodiments, nozzle through-hole 15/16 has a cavity 153/163 that is operatively adapted (i.e., dimensioned, configured or otherwise designed) such that fuel flowing therethrough has an axis of flow that is curved.

Examples of factors that contribute to such differences in axis of flow may include, but are not be limited to, any combination of: (1) a different angle between (i) cavity 153/163 and (ii) inlet face 11 and/or outlet face 14, (2) inlet openings 151/161 and/or cavities 153/163 and/or outlet openings 152/162 that not being aligned or parallel to each other, or are aligned along different directions, or are parallel but not aligned, or are intersecting but not aligned, and/or (3) any other conceivable geometric relationship two or three non-aligned line segments could have.

The disclosed nozzles 10 may comprise (or consist essentially of or consist of) any one of the disclosed nozzle features or any combination of two or more of the disclosed nozzle features. In addition, although not shown in the figures and/or described in detail herein, the nozzles 10 of the present invention may further comprise one or more nozzle features disclosed in (1) U.S. Provisional Patent Application Ser. No. 61/678,475 (3M Docket No. 69909US002 entitled “GDI Fuel Injectors with Non-Coined Three-Dimensional Nozzle Outlet Face”) filed on Aug. 1, 2012 (e.g., outlet face overlapping features 149), (2) U.S. Provisional Patent Application Ser. No. 61/678,356 (3M Docket No. 69910US002 entitled “Targeting of Fuel Output by Off-Axis Directing of Nozzle Output Streams”) filed on Aug. 1, 2012 (e.g., specifically disclosed nozzle through-holes 15 and/or inlet face features 118 that reduce a SAC volume of a fuel injector), (3) U.S. Provisional Patent Application Ser. No. 61/678,305 (3M Docket No. 69912US002 entitled “Fuel Injectors with Improved Coefficient of Fuel Discharge”) filed on Aug. 1, 2012 (e.g., specifically disclosed nozzle through-holes 15 having a relatively high coefficient of discharge (COD) value), and (4) U.S. Provisional Patent Application Ser. No. 61/678,288 (3M Docket No. 69913US002 entitled “Fuel Injectors with Non-Coined Three-dimensional Nozzle Inlet Face”) filed on Aug. 1, 2012 (e.g., a non-coined three-dimensional inlet face 11), the subject matter and disclosure of each of which is herein incorporated by reference in its entirety.

The disclosed nozzles 10 may be formed using any method as long as the resulting nozzle 10 has one or more nozzle through-holes 15 therein, and at least one nozzle through-hole 15 has (i) a single inlet opening 151 along an inlet face 11 and multiple outlet openings 152 along an outlet face 14 or (ii) multiple inlet openings 151 along an inlet face 11 and a single outlet opening 152 along an outlet face 14 as described herein. Although suitable methods of making nozzles 10 of the present invention are not limited to the methods disclosed in International Patent Application Serial No. US2012/023624, nozzles 10 of the present invention may be formed using the methods (e.g., using a multiphoton process, such as a two photon process) disclosed in International Patent Application Serial No. US2012/023624. See, for example, the method steps shown in FIGS. 1A-1M and the description thereof in International Patent Application Serial No. US2012/023624.

### Additional Embodiments

### Nozzle Embodiments

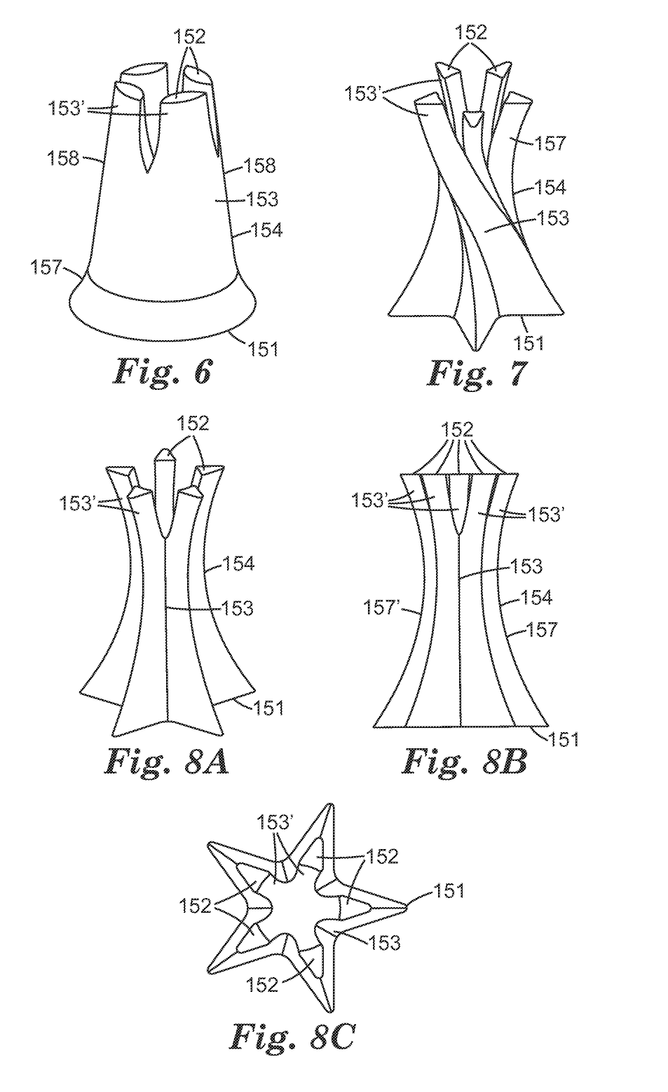

1. A fuel injector nozzle 10 comprising: an inlet face 11; an outlet face 14 opposite said inlet face 11; and at least one nozzle through-hole 15 comprising (i) a single inlet opening 151 on said inlet face 11 connected to multiple outlet openings 152 on said outlet face 14 by a cavity 153 defined by an interior surface 154, or (ii) multiple inlet openings 151 on said inlet face 11 connected to a single outlet opening 151 on said outlet face 14 by a cavity 153 defined by an interior surface 154.
2. The nozzle 10 of embodiment 1, wherein said at least one nozzle through-hole 15 is a plurality of nozzle through-holes 15 comprising (i), (ii), or both (i) and (ii).
3. The nozzle 10 of embodiment 1 or 2, wherein said inlet face 11 and said outlet face 14 are substantially parallel.
4. The nozzle 10 of any one of embodiments 1 to 3, wherein said nozzle 10 is substantially flat.
5. The nozzle 10 of any one of embodiments 1 to 4, wherein said cavity 153 of each said nozzle through-hole 15 comprises multiple cavity passages 153′ extending along said cavity 153, and each said cavity passage 153′ leads to one said outlet opening 152 or extends from one said inlet opening 151.
6. The nozzle 10 of any one of embodiments 1 to 5, wherein said cavity 153 of each said nozzle through-hole 15 comprises multiple cavity passages 153′ extending greater than or equal to about 10% (or any fractional percent greater than 10% in increments of 1.0%) of a maximum overall length L of said cavity 153. As used herein, the phrase “maximum overall length L of a given cavity 153” represents the greatest distance extending from an inlet opening 151 to an outlet opening 152 of the given cavity 153. As shown, for example, in FIG. 1, length L of cavity 153 extends along curved surface portion 157 of nozzle 10.
7. The nozzle 10 of embodiment 6, wherein said multiple cavity passages 153′ extend in the range of from about 10% to about 90% (or any percent or range therebetween in increments of 1.0%) of a maximum overall length L of said cavity 153.
8. The nozzle 10 of any one of embodiments 5 to 7, wherein there are at least 4 of said cavity passages 153′ within each said nozzle through-hole 15.
9. The nozzle 10 of any one of embodiments 5 to 7, wherein there are in the range of from 2 to 50, or any number or range therebetween in increments of 1 (e.g., from 3 to 20), of said cavity passages 153′ within each said nozzle through-hole 15.
10. The nozzle 10 of any one of embodiments 1 to 9, wherein said at least one nozzle through-hole 15 comprises one inlet opening 151 and multiple outlet openings 152.
11. The nozzle 10 of embodiment 10, wherein each said cavity passage 153′ leads to one said outlet opening 152 of said multiple outlet openings 152.
12. The nozzle 10 of any one of embodiments 1 to 9, wherein said at least one nozzle through-hole 15 comprises multiple inlet openings 151 and one outlet opening 152.
13. The nozzle 10 of embodiment 12, wherein each said cavity passage 153′ leads to one said inlet opening 151 of said multiple inlet openings 151.
14. The nozzle 10 of any one of embodiments 1 to 11, wherein said at least one nozzle through-hole 15 comprises multiple outlet openings 152, and each said cavity passage 153′ leads to one said outlet opening 152 such that a fluid (not shown) flowing through said nozzle through-hole 15 forms multiple fluid streams that (1) substantially converge (i.e., some, most, all, or at least an otherwise commercially acceptable number of the streams converge) at generally or precisely one location a desired distance from the outlet face 14 of said nozzle 10, (2) substantially diverge in multiple separate directions for a distance from the outlet face of said nozzle, (3) remain substantially parallel for a desired distance from the outlet face 14 of said nozzle 10, or (4) any combination of (1), (2) and (3). As used herein, the phrase “substantially converge” refers to adjacent fluid streams that contact one another. The degree of contact between adjacent fluid streams may vary, but, at a minimum, the paths of the adjacent fluid streams overlap one another. As used herein, the phrase “substantially diverge” refers to fluid streams that move away from one another. For example, a nozzle through-hole 15 having a cavity 153 as shown in FIG. 6 produces four separate fluid streams (not shown) that are initially parallel with one another, but eventually converge to some extent a distance from outlet openings 152. In contrast, a nozzle through-hole 15 having a cavity 153 as shown in FIG. 7 or FIG. 8A-8C produces five separate fluid streams (not shown) that start to diverge from one another as soon as the fluid streams exit outlet openings 152.

The distances at which a fuel stream, for each injector type (i.e., PFI, GDI, or DI), should break-up depend on a number of factors. For example, such a distance for a PFI type fuel injector system, the director plate port-to-port spacing, as well as the surface tension of the liquid fuel, can affect this distance. If the fuel stream breaks-up too far out from the nozzle, or if the individual stream velocities are too similar, the droplets may coalesce, which can have a negative effect on fuel efficiency. With the present invention, individual fuel stream speeds can be made substantially different, e.g., by changing the ratio of the inlet opening area to outlet opening area, for nozzle through-holes having larger inlet openings and smaller outlet openings.

If the goal is to have individual fuel streams converge at a point and break-up upon impact, than the distance to such a point would depend on the particulars (dimensions, configuration, and design) of the chosen internal combustion engine. In one example of a PFI application, it can be desirable for the fuel stream or spray to break-up right before the intake valve so as to allow the air coming into the combustion chamber (i.e., engine cylinder) to carry the small droplets of fuel with them into the cylinder. Smaller fuel droplets can more easily follow the flow path of the air, thus minimizing contact with portions (e.g., the back) of the valve. Allowing the fuel spray to break-up against the valve can cause carbon or coke buildup on internal surfaces. However, if the strategy is to use the back of the valve to breakup the spray, than it may be desirable to cause the fuel droplets to coalesce as soon as, or soon after, they exit the fuel injector nozzle. The coalescence of the fuel droplets can minimize momentum loss as the fuel spray travels through the air. Such reduction in momentum loss can result in the fuel droplets hitting the back of the intake valve with a higher momentum, which can cause a greater degree of fuel stream/spray break-up.
15. The nozzle 10 of embodiment 14, wherein each said cavity passage 153′ leads to one said outlet opening 152 such that a fluid flowing through said nozzle through-hole 15 forms multiple fluid streams that remain substantially parallel for a desired distance from the outlet face 14 of said nozzle 10.
16. The nozzle 10 of embodiment 15, wherein said fluid streams are substantially parallel with a nozzle central axis 20 extending along a normal line perpendicular to the outer face 14 of said nozzle 10.
17. The nozzle 10 of embodiment 14, wherein each said cavity passage 153′ leads to one said outlet opening 152 such that a fluid flowing through said nozzle through-hole 15 forms multiple fluid streams that substantially converge at about one location a desired distance from the outlet face 14 of said nozzle 10.
18. The nozzle 10 of embodiment 14, wherein each said cavity passage 153′ leads to one said outlet opening 152 such that a fluid flowing through said nozzle through-hole 15 forms multiple fluid streams that substantially diverge in multiple separate directions.
19. The nozzle 10 of embodiment 17 or 18, wherein said fluid streams are substantially off-axis relative to a nozzle central axis 20 extending along a normal line perpendicular to the outer face 14 of said nozzle 10.
20. The nozzle 10 of embodiment 14, wherein each said cavity passage 153′ leads to one said outlet opening 152 such that a fluid flowing through said nozzle through-hole 15 forms multiple fluid streams that (1) substantially converge at about one location a distance from the outlet face 14 of said nozzle 10, (2) substantially diverge in multiple separate directions for a distance from the outlet face of said nozzle, and (3) remain substantially parallel for a desired distance from the outlet face 14 of said nozzle 10.
21. The nozzle 10 of embodiment 20, wherein said fluid streams comprise streams that are substantially parallel with an off-axis relative to a nozzle central axis 20 extending along a normal line perpendicular to the outer face 14 of said nozzle 10.
22. The nozzle 10 of any one of embodiments 1 to 21, wherein each said cavity passage 153′ leads to one said outlet opening 152 such that a fluid flowing through said at least one nozzle through-hole 15 forms fluid streams directed to two or more separate locations a desired distance from the outlet face 14 of said nozzle 10.

### Typical Distances for Fuel Stream Break-Up Upon Exiting a Nozzle Outlet Face

| | Converging* | | Diverging* | | Parallel* | |
|---|---|---|---|---|---|---|
| | Min | Max | Min | Max | Min | Max |
| PFI | 0.01 mm | 400 mm | 15 mm | 100 mm | 25 mm | 400 mm |
| GDI | 0.01 mm | 150 mm | 10 mm | 150 mm | 10 mm | 200 mm |
| DI | 0.01 mm | 200 mm | 10 mm | 250 mm | 10 mm | 250 mm |

*Refers to the path followed by multiple fuel streams formed from multiple nozzle through-holes, multiple outlet openings of a single nozzle through-hole, or both.

23. The nozzle 10 of any one of embodiments 14 to 17 and 19 to 21, wherein the distance is in the range of from about 10 mm to about 400 mm (or any number or range therebetween in increments of 1.0 mm)
24. The nozzle 10 of any one of embodiments 14 to 17 and 19 to 21, wherein the distance is in the range of from about 0.01 mm to about 400 mm (or any number or range therebetween in increments of 0.01 mm)
25. The nozzle 10 of any one of embodiments 14, 18 to 20 and 22, wherein the distance is in the range of from about 10 mm to about 250 mm (or any number or range between about 0.01 mm and about 250 mm in increments of 0.01 mm)
26. The nozzle 10 of any one of embodiments 1 to 25, wherein said at least one nozzle through-hole 15 is a plurality of nozzle through-holes 15.
27. The nozzle 10 of any one of embodiments 1 to 26, further comprising one or more arrays 28 of nozzle through-holes 15 for directing a fluid from said inlet face 11 to said outlet face 14, wherein at least one of said one or more arrays 28 comprises said at least one nozzle through-hole 15.
28. The nozzle 10 of any one of embodiments 1 to 27, further comprising one or more additional nozzle through-holes 16, with each additional nozzle through-hole 16 comprising a single inlet opening 161 on said inlet face 11 connected to a single outlet opening 162 on said outlet face 14 by a cavity 163 defined by an interior surface 164.
29. The nozzle 10 of any one of embodiments 1 to 28, wherein at least one said nozzle through-hole 15/16 is a curved nozzle through-hole 15/16 comprising an interior surface 154/164 with at least one curved portion 157 that is curved along a direction extending directly from an inlet opening 151/161 to an outlet opening 152/162. When discussed herein, curved portion 157 or liner portion 158, and/or any other surface portion form all or a part of a “curved surface profile” of internal surface 154 that extends directly from at least one inlet opening 151 to at least one outlet opening 152. The “curved surface profile” can refer to (i) a shortest distance along internal surface 154 that extends directly from at least one inlet opening 151 to at least one outlet opening 152, (ii) a longest distance along internal surface 154 that extends directly from at least one inlet opening 151 to at least one outlet opening 152, or (iii) any other distance therebetween along internal surface 154 that extends directly from at least one inlet opening 151 to at least one outlet opening 152.
30. The nozzle 10 of embodiment 29, wherein said curved portion 157 extends directly along the interior surface 154/164 of said curved nozzle through-hole 15/16, beginning proximate to an inlet opening 151/161 (i.e., extends directly in a direction from at least one inlet opening 151 to at least one outlet opening 152).
31. The nozzle 10 of embodiment 30, wherein said curved portion 157 extends to at least one outlet opening 152/162 (i.e., extends directly in a direction from at least one inlet opening 151 to at least one outlet opening 152).
32. The nozzle 10 of any one of embodiments 29 to 31, wherein the interior surface 154/164 of said curved nozzle through-hole 15/16 comprises a non-curved linear portion 158 on a side of said interior surface 154/164 opposite said curved portion 157, with said linear portion 158 being non-curved along a direction extending directly from an inlet opening 151/161 to an outlet opening 152/162.
33. The nozzle 10 of embodiment 32, wherein said linear portion 158 defines an obtuse angle A with a portion of the inlet face 11 of said nozzle 10.
34. The nozzle 10 of embodiment 32 or 33, wherein said linear portion 158 extends to at least one outlet opening 152/162.
35. The nozzle 10 of any one of embodiments 32 to 34, wherein the interior surface 154/164 of said curved nozzle through-hole 15/16 comprises another curved portion 157′ that is curved along a direction extending directly from an inlet opening 151/161 to an outlet opening 152/162, with said other curved portion 157′ beginning proximate to an inlet opening 151/161 and ending where said linear portion 158 begins.
36. The nozzle 10 of embodiment 35, wherein said other curved portion 157′ is convex shaped.
37. The nozzle 10 of any one of embodiments 29 to 36, wherein said at least one curved portion 157 of the interior surface 154/164 of said curved nozzle through-hole 15/16 comprises two curved portions 157/157′ located on opposite sides of the cavity 153/163 of said curved nozzle through-hole 15/16 (i.e., each extends directly in a direction from at least one inlet opening 151 to at least one outlet opening 152).
38. The nozzle 10 of embodiment 37, wherein one of said two curved portions 157/157′ has a convex shape and the other of said two curved portions 157/157′ has a concave shape (i.e., each extends directly in a direction from at least one inlet opening 151 to at least one outlet opening 152).
39. The nozzle 10 of embodiment 37, wherein one of said two curved portions 157/157′ has a first convex shape and the other of said two curved portions 157/157′ has a second convex shape (i.e., each extends directly in a direction from at least one inlet opening 151 to at least one outlet opening 152).
40. The nozzle 10 of any one of embodiments 29 to 39, wherein the inlet opening 151/161 of said curved nozzle through-hole 15/16 has a periphery 151′/161′ defined by a convex shaped curved portion of the interior surface 154/164 of said curved nozzle through-hole 15/16.
41. The nozzle 10 of any one of embodiments 1 to 40, wherein (a) said inlet opening 151 or said multiple inlet openings 151 of at least one nozzle through-hole 15 form an inlet opening pattern along said inlet face 11, said inlet opening pattern having an inlet opening periphery and an inlet opening periphery diameter i_{d}, (b) said multiple outlet openings 152 or said outlet opening 152 of the at least one nozzle through-hole 15 form an outlet opening pattern along said outlet face 14, said outlet opening pattern having an outlet opening periphery and an outlet opening periphery diameter o_{d}, with (i) said overall inlet opening periphery diameter i_{d}, (ii) said overall outlet opening periphery diameter o_{d}, or (iii) both of said overall inlet opening periphery diameter i_{d} and said overall outlet opening periphery diameter o_{d} being independently greater than a cavity diameter c_{d} along at least a portion of said cavity 153 of the at least one nozzle through-hole 15.
42. The nozzle 10 of any one of embodiments 1 to 41, wherein (a) said inlet opening 151 or said multiple inlet openings 151 form an inlet opening pattern along said inlet face 11, said inlet opening pattern having an inlet opening periphery and an inlet opening periphery diameter i_{d}, (b) said multiple outlet openings 152 or said outlet opening 152 form an outlet opening pattern along said outlet face 14, said outlet opening pattern having an outlet opening periphery and an outlet opening periphery diameter o_{d}, with said outlet opening periphery diameter o_{d} being independently greater than a cavity diameter c_{d} along at least a portion of said cavity 153.
43. The nozzle 10 of any one of embodiments 1 to 42, wherein (a) said inlet opening 151 or said multiple inlet openings 151 form an inlet opening pattern along said inlet face 11, said inlet opening pattern having an inlet opening periphery and an inlet opening periphery diameter i_{d}, (b) said multiple outlet openings 152 or said outlet opening 152 form an outlet opening pattern along said outlet face 14, said outlet opening pattern having an outlet opening periphery and an outlet opening periphery diameter o_{d}, with each of (i) said overall inlet opening periphery diameter i_{d} and (ii) said overall outlet opening periphery diameter o_{d} being independently greater than a cavity diameter c_{d} along at least a portion of said cavity 153.
44. The nozzle 10 of any one of embodiments 5 to 43, wherein said cavity passages 153′ rotate within an x-y plane as said cavity passages 153′ extend through said nozzle 10. See, for example, rotating cavity passages 153′ within cavity 153 shown in FIG. 7.
45. The nozzle 10 of any one of embodiments 1 to 44, wherein at least one inlet opening 151 and at least one outlet opening 152 for at least one nozzle through-hole 15 have a similar shape. It should be noted that a given nozzle through-hole 15 with multiple inlet openings 151 or multiple outlet openings 152 may comprise two or more inlet openings 151 or two or more outlet openings 152 having different opening diameters and/or opening shapes. Such an opening configuration produces individual fluid streams having different fluid velocities and droplet sizes from a single nozzle through-hole 15.
46. The nozzle 10 of any one of embodiments 1 to 45, wherein at least one inlet opening 151 and at least one outlet opening 152 for at least one nozzle through-hole 15 have a different shape.
47. The nozzle 10 of any one of embodiments 1 to 46, wherein each nozzle through-hole 15/16 has a total inlet opening area and a total outlet opening area, and said total inlet opening area is greater than said total outlet opening area.
48. The nozzle 10 of any one of embodiments 1 to 47, wherein said nozzle 10 has an overall ratio of total inlet opening area to total outlet opening area in the range of from greater than 1.0 to about 250 (or any number or range therebetween in increments of 0.1).
49. The nozzle 10 of any one of embodiments 1 to 47, wherein said nozzle 10 has an overall ratio of total inlet opening area to total outlet opening area ranging from about 0.0025 (e.g., 1 to 400) to about 400 (e.g., 400 to 1) (or any ratio or ratio range therebetween in increments of 0.0025 (ratio shown as fraction) or 1 to 1 (ratio shown as separate numbers)).
50. The nozzle 10 of any one of embodiments 1 to 49, wherein said nozzle 10 further comprises one or more outlet surface features 150/1519 extending along said outlet face 14. Outlet surface features 150/1519 extending along outlet face 14 may include, but are not limited to, anti-coking microstructures 150 as shown in FIG. 5, fluid impingement members 1519 as shown in FIG. 5, or a combination thereof. Other suitable outlet surface features for use in the nozzles 10 of the present invention include, but are not limited to, overlapping outlet face structures 149 as disclosed in U.S. Provisional Patent Application Ser. No. 61/678,475 (3M Docket No. 69909US002 entitled “GDI Fuel Injectors with Non-Coined Three-Dimensional Nozzle Outlet Face”) referenced above.
51. The nozzle 10 of embodiment 50, wherein said one or more outlet surface features 1519 comprise one or more fluid impingement members 1519 positioned along said outer face 14.
52. The nozzle 10 of any one of embodiments 1 to 51, wherein each inlet opening 151/161 has a diameter of less than about 400 microns (or less than about 300 microns, or less than about 200 microns, or less than about 160 microns, or less than about 100 microns) (or any diameter between about 10 microns and 400 microns in increments of 1.0 micron, e.g., 10, 11, 12, etc. microns). As used herein, the term “diameter” is used to describe a maximum distance across an inlet opening 151/161 (or an outlet opening 152/162).
53. The nozzle 10 of any one of embodiments 1 to 52, wherein each outlet opening 152/162 has a diameter of less than about 400 microns (or less than about 300 microns, or less than about 200 microns, or less than about 100 microns, or less than about 50 microns, or less than about 20 microns) (or any diameter between about 10 microns and 400 microns in increments of 1.0 micron, e.g., 10, 11, 12, etc. microns).
54. The nozzle 10 of any one of embodiments 1 to 53, wherein the nozzle 10 comprises a metallic material, an inorganic non-metallic material (e.g., a ceramic), or a combination thereof.
55. The nozzle 10 of any one of embodiments 1 to 54, wherein the nozzle 10 comprises a ceramic selected from the group comprising silica, zirconia, alumina, titania, or oxides of yttrium, strontium, barium, hafnium, niobium, tantalum, tungsten, bismuth, molybdenum, tin, zinc, lanthanide elements having atomic numbers ranging from 57 to 71, cerium and combinations thereof.

### Fuel Injector Embodiments

56. A fuel injector 101 comprising a nozzle 10 according to any one of embodiments 1 to 55.

### Fuel Injector System Embodiments

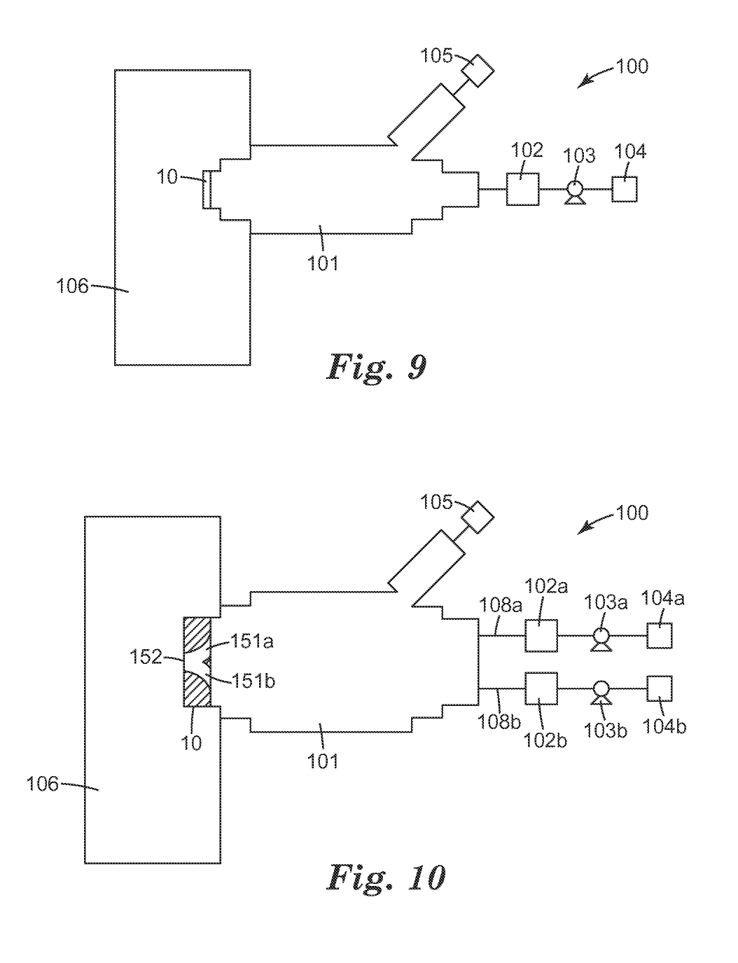

57. A fuel injection system 100 of a vehicle 200 comprising the fuel injector 101 of embodiment 56. As shown in FIG. 9, exemplary fuel injector system 100 may comprise, inter alia, fuel injector 101, fuel source/tank 104, fuel pump 103, fuel filter 102, fuel injector electrical source 105, and internal combustion engine 106.
58. The fuel injection system 100 of embodiment 57, further comprising two or more fuel component reservoirs 104a/104b, and tubing 108a/108b extending between each fuel component reservoir 104a/104b and a volume along said inlet face 11 of said nozzle 10, said at least one nozzle through-hole 15 comprising multiple inlets 151a/151b and a single outlet 152 so as to mix two or more fuel components (not shown) from said two or more fuel component reservoirs 104a/104b as the fuel components travel through nozzle 10. As shown in FIG. 10, in addition to the two or more fuel component reservoirs 104a/104b and tubing 108a/108b, exemplary fuel injector system 100 may further comprise, inter alia, fuel injector 101, fuel component pumps 104a/104b, fuel component filters 102a/102b, fuel injector electrical source 105, and internal combustion engine 106.

### Methods of Making Nozzles Embodiments

59. A method of making the nozzle 10 of any one of embodiments 1 to 55.
60. A method of making a fuel injector nozzle 10, said method comprising:
   forming at least one nozzle through-hole 15 within the fuel injector nozzle 10 such that the at least one nozzle through-hole 15 extends from an inlet face 11 to an outlet face 14 opposite the inlet face 11 of the nozzle 10, the at least one nozzle through-hole 15 comprising (i) a single inlet opening 151 on the inlet face 11 connected to multiple outlet openings 152 on the outlet face 14 by a cavity 152 defined by an interior surface 154, or (ii) multiple inlet openings 151 on the inlet face 11 connected to a single outlet opening 152 on the outlet face 14 by a cavity 153 defined by an interior surface 154.
61. The method of embodiment 60, said forming step comprising: applying a nozzle-forming material over a nozzle forming microstructured pattern comprising one or more nozzle hole forming features; separating the nozzle-forming material from the nozzle forming microstructured pattern to provide a nozzle 10; and removing material, as needed, from the nozzle 10 to form the at least one nozzle through-hole 15. See, for example, the method steps shown in FIGS. 1A-1M and the description thereof in International Patent Application Serial No. US2012/023624.
62. The method of embodiment 61, wherein the nozzle forming microstructured pattern further comprises one or more planar control cavity forming features.
63. The method of embodiment 61 or 62, said forming step further comprising: providing a microstructured mold pattern defining at least a portion of a mold and comprising at least one replica nozzle hole; and molding a first material onto the microstructured mold pattern so as to form the nozzle forming microstructured pattern.
64. The method of embodiment 63, wherein the microstructured mold pattern comprises at least one fluid channel feature connecting at least one replica nozzle hole to (a) at least one other replica nozzle hole, (b) a portion of the mold beyond an outer periphery of the microstructured mold pattern, or (c) both (a) and (b).
65. The method of embodiment 63 or 64, wherein the first material comprises a material having a degree of elasticity.
66. The method of any one of embodiments 63 to 65, wherein the first material comprises polypropylene or polycarbonate. It should be noted that any of a number of moldable polymers may be used as the first material. Suitable moldable polymers include, but are not limited to, polycarbonate, liquid crystalline polymers (LCP), polyether ether ketone (PEEK), polypropylene (PP), thermoplastic elastomers (TPE) such as thermoplastic urethanes (TPU), fluoropolymers, polymer encapsulated metallic particles (e.g., such of those used in metal injection molding (MIM) and those described above.
67. The method of any one of embodiments 60 to 66, wherein the at least one nozzle through-hole 15 comprises a plurality of nozzle through-holes 15.
68. The method of any one of embodiments 60 to 67, wherein said forming step further comprises: forming one or more additional nozzle through-holes 16 within the fuel injector nozzle 10 such that each additional nozzle through-hole 16 extends from the inlet face 11 to the outlet face 14 of the nozzle 10, each additional nozzle through-hole 16 comprising (i) a single inlet opening 161 on the inlet face 11 connected to a single outlet opening 162 on the outlet face 14 by a cavity 163 defined by an interior surface 164.

### Methods of Making Fuel Injector Embodiments

69. A method of making a fuel injector 101, said method comprising incorporating the nozzle 10 of any one of embodiments 1 to 55 into a fuel injector 101.

### Methods of Making Fuel Injection Systems Embodiments

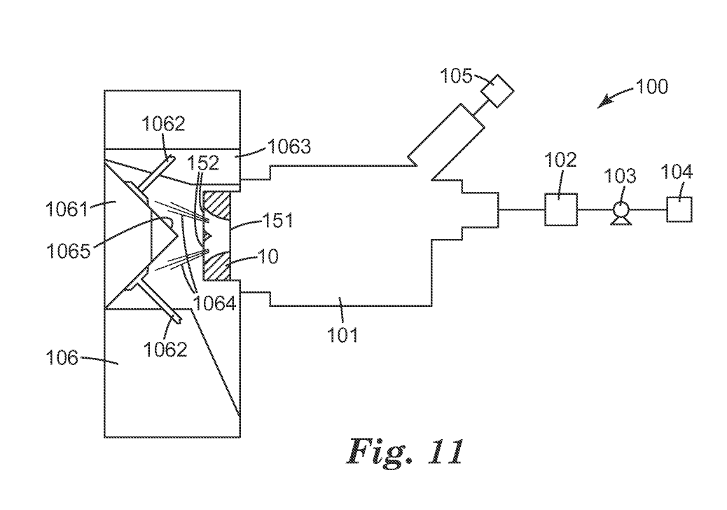

70. A method of making a fuel injection system 100 of a vehicle 200, said method comprising incorporating the fuel injector 101 of embodiment 69 into the fuel injection system 100.
71. The method of embodiment 70, wherein the fuel injection system 100 comprises two intake valves 1062 per cylinder 1063, and the at least one nozzle through-hole 15 independently directs fluid 1064 down corresponding throats of a split intake manifold 1065 towards the two intake valves 1062. As shown in FIG. 11, exemplary fuel injector system 100 may comprise, inter alia, fuel injector 101, fuel source/tank 104, fuel pump 103, fuel filter 102, fuel injector electrical source 105, and internal combustion engine 106. Internal combustion engine 106 further comprises combustion chamber 1061.

### Methods of Using Fuel Injection Systems Embodiments

72. A method of using the fuel injection system 100 of embodiment 58, said method comprising: introducing two or more fuel components (not shown) into the fuel injection system 100 such that each fuel component independently enters separate inlet openings 151 of a single nozzle through-hole 15 and exits a single outlet opening 152 of the single nozzle through-hole 15 so as to mix the two or more fuel components from the two or more fuel reservoirs 104a/104b as the fuel components travel through the nozzle 10.

### Nozzle Pre-Form Embodiments

73. A nozzle pre-form suitable for forming the nozzle 10 of any one of embodiments 1 to 55. See, for example, other nozzle pre-forms and how the nozzle pre-forms are utilized to form nozzles in FIGS. 1A-1M and the description thereof in International Patent Application Serial No. US2012/023624.

### Microstructured Pattern Embodiments

74. A microstructured pattern suitable for forming the nozzle 10 of any one of embodiments 1 to 55. See, for example, other microstructured patterns and how the microstructured patterns are utilized to form nozzles in FIGS. 1A-1M and the description thereof in International Patent Application Serial No. US2012/023624.

In any of the above embodiments, nozzle 10 may comprise a nozzle plate 10 having a substantially flat configuration typically with at least a portion of inlet face 11 substantially parallel to at least a portion of outlet face 14.

Desirably, nozzles 10 of the present invention each independently comprise a monolithic structure. As used herein, the term “monolithic” refers to a nozzle having a single, integrally formed structure, as oppose to multiple parts or components being combined with one another to form a nozzle.

It can be desirable for the thickness of a fuel injector nozzle 10 to be at least about 100 μm, preferably greater than about 200 μm; and less than about 3 mm, preferably less than about 1 mm, more preferably less than about 500 μm (or any thickness between about 100 μm and about 3 mm in increments of 1.0 μm).

Further, although not shown in the figures, any of the herein-described nozzles 10 may further comprise one or more alignment surface features that enable (1) alignment of nozzle 10 (i.e., in the x-y plane) relative to a fuel injector 101 and (2) rotational alignment/orientation of nozzle 10 (i.e., a proper rotational position within the x-y plane) relative to a fuel injector 101. The one or more alignment surface features aid in positioning nozzle 10 and nozzle through-holes 15 therein so as to be accurately and precisely directed at one or more target location iₜ as discussed above. The one or more alignment surface features on nozzle 10 may be present along inlet face 11, outlet face 14, periphery 19, or any combination of inlet face 11, outlet face 14 and periphery 19. Further, the one or more alignment surface features on nozzle 10 may comprise, but are not limited to, a visual marking, an indentation within nozzle 10, a raised surface portion along nozzle 10, or any combination of such alignment surface features.

It should be understood that although the above-described nozzles, nozzle plates, fuel injectors, fuel injector systems, and methods are described as “comprising” one or more components, features or steps, the above-described nozzles, nozzle plates, fuel injectors, fuel injector systems, and methods may “comprise,” “consists of,” or “consist essentially of” any of the above-described components and/or features and/or steps of the nozzles, nozzle plates, fuel injectors, fuel injector systems, and methods. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of” or “consisting of” or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a nozzle, nozzle plate, fuel injector, fuel injector system, and/or method that “comprises” a list of elements (e.g., components or features or steps) is not necessarily limited to only those elements (or components or features or steps), but may include other elements (or components or features or steps) not expressly listed or inherent to the nozzle, nozzle plate, fuel injector, fuel injector system, and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a nozzle, nozzle plate, fuel injector, fuel injector system, and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Further, it should be understood that the herein-described nozzles, nozzle plates, fuel injectors, fuel injector systems, and/or methods may comprise, consist essentially of, or consist of any of the herein-described components and features, as shown in the figures with or without any additional feature(s) not shown in the figures. In other words, in some embodiments, the nozzles, nozzle plates, fuel injectors, fuel injector systems, and/or methods of the present invention may have any additional feature that is not specifically shown in the figures. In some embodiments, the nozzles, nozzle plates, fuel injectors, fuel injector systems, and/or methods of the present invention do not have any additional features other than those (i.e., some or all) shown in the figures, and such additional features, not shown in the figures, are specifically excluded from the nozzles, nozzle plates, fuel injectors, fuel injector systems, and/or methods.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### Example 1

The preparation of a nozzle plate begins with the design of its through-holes using conventional computer aided design software (CAD). A drawing of the intended design is prepared in which the individual through-hole has a single aperture or opening on one end and four individual apertures or openings on the other end. The cross-sectional split between the two ends (i.e., where one cavity splits into four) occurs at approximately 70% of the through thickness. The design of the through-hole used in the nozzle plate of Example 1 is shown in FIG. 6.

The nozzle plate of this example is designed using CAD layout software as an array of the aforementioned through-holes with a centrally positioned through-hole surrounded by additional through-holes arranged in concentric rings about the first to form a typical 2-dimensional hexagonal packing order of 37 through-holes.

The computer file containing both the through-hole design information and the positional information for through-holes within the nozzle plate array is used to execute the multi-photon exposure process within a photoresist layer, both of which are described in PCT/US2010/043628, which is incorporated herein in its entirety. Upon completion of the writing or exposure process the photoresist is “developed” by exposure to a solvent to wash away all photoresist material which was not exposed therefore not polymerized and is soluble. Once dried of any residual solvent a “master form” or “master” was obtained upon which solid forms in the shape designed as the through-holes remained.

As this example is made by a prototyping method this master form is used directly and a microstructured pattern was made electrically conductive by deposition of a thin layer of Silver applied via sputtering. This Silver-coated microstructured pattern is then electroplated with Nickel from a Nickel sulfamate solution so as to build up adequate material thickness from which the final nozzle plate will be formed.

Upon removal from the electroplating bath the Nickel plated side was subjected to an abrasive removal of material so as to remove enough material to expose the tips of the photoresist present in the microstructured features. The extent to which the material was removed was that necessary to provide openings which were of adequate size for the intended fluid mass flow rate desired of the nozzle plate, for example, to match that of a desired commercially available fuel injector.

This nozzle plate was attached to a commercially available fuel injector from which the original nozzle plate was carefully machined away. The nozzle plate of this example was carefully aligned such that the through-hole array was centered about the ball valve aperture and was laser welded onto the injector barrel to secure it to the injector. The excess material (i.e. the flange that extended beyond the barrel of the injector body) was machined away resulting in a fully functioning fuel injector. This injector was subjected to a series of tests including a leak test which ensured that the laser welding process had not distorted the ball valve seat in such a manner that the seal could not be formed and the injector leak.

Results

A fuel injector test bench available from ASNU Corporation Europe Limited (65-67 Glencoe Road, Bushey, WD23 3DP, United Kingdom) was used to collect mass flow rate information as a function of fluid supply pressure. Flo-Rite™ Fuel Injector FlowTest Fluid (1000-3FLO) recommended by ASNU for used with the equipment was used instead of gasoline. It is a hydrocarbon blend without the high flammability of gasoline and, thus for safety purposes, it is more suitable for usage in testing.

The fuel injector used with the nozzle plate of this example (Motorcraft Part Number 8S4Z9F593A) is manufactured by Robert Bosch GmbH and is suited for use in the 2.0 liter, in-line 4 cylinder Duratec™ engine manufactured by the Ford Motor Company. Results for a original equipment manufacturer's (OEM) part are provided for reference in Table 1 below.

TABLE 1
results for nozzle plate (Example 1) as compared to original OEM nozzle plate

| | | | Design | | |
|---|---|---|---|---|---|
| | | | OEM | Example #1 | units |
| Orifice count: | | Inlet: | 4 | 37 | |
| | | Outlet: | 4 | 148 | |
| Nozzle plate thickness: | | | 0.065 | 0.0119 | inch |
| Total Open Area (outlet): | | | 284956 | 200993 | um² |
| Injector body: | | | Motorcraft Part No. | | |
| | | | 8S4Z9F593A | | |
| Attachment Method: | | | Laser Welding | | |
| Bench Testing | Leak Test: | | PASS | PASS | |
| (ASNU Testing) | Flow Rate | 2.0 bar: | 138.2 | 135.0 | grams/minute |
| | (static) @ | 2.5 bar: | 157.9 | 154.4 | grams/minute |
| | pressures of: | 3.0 bar: | 175.8 | 171.2 | grams/minute |
| | | 3.5 bar: | 190.1 | 187.5 | grams/minute |
| | | 4.0 bar: | 203.0 | 202.0 | grams/minute |

The nozzle plate of this example has a higher count of smaller individual outlet holes and provides a comparable mass flow rate to the original equipment manufacture's (OEM) plate, and thereby, it is capable of distributing the fluid more uniformly over that area to which it is delivered. With smaller nozzle outlets produce smaller droplet sizes, which enables the fuel to be more highly atomized, resulting in a higher surface area, which has more exposure to oxygen in air and will burn more rapidly and completely than larger droplets. As a result fuel consumption and hydrocarbon emissions can be lowered.

From the above disclosure of the general principles of the present invention and the preceding detailed description, those skilled in this art will readily comprehend the various modifications, re-arrangements and substitutions to which the present invention is susceptible. Therefore, the scope of the invention should be limited only by the following claims and equivalents thereof. In addition, it is understood to be within the scope of the present invention that the disclosed and claimed nozzles may be useful in other applications (i.e., not as fuel injector nozzles). Therefore, the scope of the invention may be broadened to include the use of the claimed and disclosed structures for such other applications.

1. A fuel injector nozzle comprising:
an inlet face;
an outlet face opposite said inlet face;
at least one nozzle through-hole comprising (i) a single inlet opening on said inlet face connected to multiple outlet openings on said outlet face by a cavity defined by an interior surface, or (ii) multiple inlet openings on said inlet face connected to a single outlet opening on said outlet face by a cavity defined by an interior surface; and
at least one fluid impingement structure for impinging fluid flowing out from at least one outlet opening on said outlet face.

2. (canceled)

3. The nozzle of claim 1, wherein said cavity of each said nozzle through-hole comprises multiple cavity passages extending along said cavity, and each said cavity passage leads to one said outlet opening or extends from one said inlet opening.

4. The nozzle of claim 3, wherein said multiple cavity passages extend in the range of from about 10% to about 90% of a maximum overall length of said cavity.

5. The nozzle of claim 3, wherein there are in the range of from 3 to 20 of said cavity passages within each said nozzle through-hole.

6. The nozzle of claim 1, wherein said at least one nozzle through-hole comprises one inlet opening and multiple outlet openings.

7. The nozzle of claim 1, wherein said at least one nozzle through-hole comprises multiple inlet openings and one outlet opening.

8. The nozzle of claim 1, wherein said at least one nozzle through-hole comprises multiple outlet openings, and each cavity passage leads to one said outlet opening such that a fluid flowing through said nozzle through-hole forms multiple fluid streams that (1) substantially converge at one location a distance from the outlet face of said nozzle, (2) substantially diverge in multiple separate directions for a distance from the outlet face of said nozzle, (3) remain substantially parallel for a distance from the outlet face of said nozzle, or (4) any combination of (1), (2) and (3).

9. The nozzle of claim 1, wherein each cavity passage leads to one said outlet opening such that a fluid flowing through said at least one nozzle through-hole forms fluid streams directed to two or more separate locations a distance from the outlet face of said nozzle.

10. The nozzle of claim 1, wherein said at least one nozzle through-hole is a plurality of nozzle through-holes.

11. The nozzle of claim 1, further comprising one or more additional nozzle through-holes, with each additional nozzle through-hole comprising a single inlet opening on said inlet face connected to a single outlet opening on said outlet face by a cavity defined by an interior surface.

12. The nozzle of claim 1, wherein at least one said nozzle through-hole is a curved nozzle through-hole comprising an interior surface with at least one curved portion that is curved along a direction from an inlet opening to an outlet opening.

13. A fuel injector comprising a nozzle according to claim 1.

14. A fuel injection system of a vehicle comprising the fuel injector of claim 13.

15. A method of making the nozzle of claim 1.

16. The nozzle of claim 7, wherein there are in the range of from 3 to 20 of said multiple inlet openings for each nozzle through-hole.

17. The nozzle of claim 16, wherein there is one fluid impingement structure for impinging fluid flowing out from each said outlet opening on said outlet face.

18. The nozzle of claim 7, wherein there is one fluid impingement structure for impinging fluid flowing out from each said outlet opening on said outlet face.

19. The nozzle of claim 1, wherein said at least one nozzle through-hole is a single nozzle through-hole comprising multiple inlet openings and one outlet opening.

20. The nozzle of claim 19, wherein there is one fluid impingement structure for impinging fluid flowing out from said one outlet opening.

21. The nozzle of claim 20, wherein there are in the range of from 3 to 20 of said inlet openings.
